(19) United States
(12) Patent Application Publication
(10) Pub. No.: US 2013/0040206 A1
(43) Pub. Date: Feb. 14, 2013

(54) ALL SOLID-STATE SECONDARY BATTERY AND A PRODUCTION METHOD OF AN ALL SOLID-STATE SECONDARY BATTERY

(71) Applicants: Naoki Yoshida, Nerima-ku (JP); Naoharu Yabuta, Toyonaka-shi (JP)

(72) Inventors: Naoki Yoshida, Nerima-ku (JP); Naoharu Yabuta, Toyonaka-shi (JP)

(73) Assignee: ZEON CORPORATION, Tokyo (JP)

(21) Appl. No.: 13/581,188

(22) PCT Filed: Feb. 25, 2011
(86) PCT No.: PCT/JP2011/054369

§ 371 Date: Sep. 21, 2012

(30) Foreign Application Priority Data
Feb. 26, 2010 (JP) 2010-043016

(51) Int. Cl. H01M 10/0562; H01M 10/04; H01M 4/62

(52) U.S. Cl. 429/307; 429/209; 429/322; 429/217; 427/58

(57) ABSTRACT

Disclosed are: an all solid state secondary battery wherein a solid electrolyte layer can be formed thin and the internal resistance is low; a method for manufacturing an all solid state secondary battery, by which an extremely thin solid electrolyte layer can be formed; and a method for manufacturing an all solid state secondary battery, by which application unevenness of a slurry composition for a solid electrolyte layer is reduced and the internal resistance can be lowered. Specifically disclosed is an all solid state secondary battery which comprises a positive electrode that has a positive electrode active material layer, a negative electrode that has a negative electrode active material layer, and a solid electrolyte layer that is arranged between the positive and negative electrode active material layers. The all solid state secondary battery is characterized in that: the thickness of the solid electrolyte layer is 1-15 μm; the solid electrolyte layer contains solid electrolyte particles (A) that have an average particle diameter of 1.5 μm or less; the solid electrolyte particles (A) have a cumulative 90% particle diameter of 2.5 μm or less; the positive electrode active material layer and the negative electrode active material layer contain solid electrolyte particles (B); and the average particle diameter of the solid electrolyte particles (B) is smaller than the average particle diameter of the solid electrolyte particles (A), with the difference being 0.3-2.0 μm (inclusive).

### TECHNICAL FIELD

The present invention relates to an all solid-state secondary battery such as an all solid-state lithium ion secondary battery or so and a production method thereof.

### BACKGROUND ART

Recently, the demand for the secondary battery of the lithium battery or so has increased for variety of use not only for the portable terminals such as the portable information terminal or the portable electronic devices or so but also for the use of the compact power storage device for home use, the motorcycle, the electric vehicle, the hybrid electric vehicle or so.

Along with the spreading of the use, further improvement of the security of the secondary battery is in demand. In order to ensure the security, the method of preventing the liquid leakage, or the method of using the inorganic solid electrolyte in place of the organic solvent electrolyte having extremely high risk of catching a flame when the leakage happens as it is highly flammable, or so are effective.

The inorganic solid electrolyte is a solid electrolyte of inflammable material consisting of inorganics, and it has higher security compared to an organic solvent electrolyte of usually used. As Patent document 1 describes, the all solid-state secondary battery using highly safe inorganic solid electrolyte are being developed.

The all solid-state secondary battery have the inorganic solid electrolyte layer as the electrolyte layer in between the positive electrode and the negative electrode. Patent document 2 and 3 describe the all solid-state lithium secondary battery formed with the solid electrolyte layer by pasting the slurry composition for the solid electrolyte layer including the solid electrolyte particle and the solvent on the positive electrode or the negative electrode then by drying.

### PRIOR ART DOCUMENT

Patent document 1: JP Unexamined Patent Application No. S59-151770
Patent document 2: JP Unexamined Patent Application No. 2009-176484
Patent document 3: JP Unexamined Patent Application No. 2009-211950

### SUMMARY OF THE INVENTION

### Technical Problems to be Solved by the Invention

However, according to the examination by the present inventors, the all solid-state lithium secondary battery described in Patent documents 2 and 3 does not have sufficient adhesiveness between the solid electrolyte layer and the active material layer, and found that in some case the internal resistance of the battery becomes large. Further, the present inventors have found that the cause thereof is due to the use of the same solid electrolyte particle that is the solid electrolyte particle having same particle diameter in the solid electrolyte layer and the active material layer.

Further, Patent document 2 forms the solid electrolyte layer by a roll press in the examples. In order to form the solid electrolyte layer by the roll press, the solid electrolyte layer needs to have certain thickness. However, when the solid electrolyte layer becomes thick, there were problems such that the internal resistance of the all solid-state secondary battery becomes large, and the output characteristic declines.

Therefore, the object of the present invention is to provide the all solid-state secondary battery capable of making the solid electrolyte layer thinner having small internal resistance. Also, the object of the present invention is to provide the production method of the all solid-state secondary battery capable of forming the extremely thin solid electrolyte layer. Furthermore, the object of the present invention is to provide the production method of the all solid-state secondary battery having small uneven coating of the slurry composition for the solid electrolyte layer and capable of making the internal resistance small.

### Means for Solving the Technical Problems

The subjects of the present invention for solving such objects are as follows.

(1) An all solid-state secondary battery comprising a positive electrode having positive electrode active material layer, a negative electrode having negative electrode active material layer and a solid electrolyte layer between these positive and negative electrodes; wherein

a thickness of said solid electrolyte layer is 1 to 15 μm,

said solid electrolyte layer includes a solid electrolyte particle A having an average particle diameter of 1.5 μm or less,

a 90% cumulative particle diameter of said solid electrolyte particle A is 2.5 μm or less,

said positive electrode active material layer and said negative electrode active material layer includes a solid electrolyte particle B,

an average particle diameter of said solid electrolyte particle B is smaller than the average particle diameter of said solid electrolyte particle A, and a difference therebetween is 0.3 μm or more and 2.0 μm or less.

(2) The all solid-state secondary battery as set forth (1) wherein said solid electrolyte particle A and/or said solid electrolyte particle B are sulfide glass comprising Li₂S and P₂S₅.
(3) The all solid-state secondary battery as set forth in (1) or (2), wherein said solid electrolyte layer includes a binder (a),

said binder (a) is an acrylic polymer including a monomer unit derived from (meth)acrylate.

(4) The all solid-state secondary battery as set forth in any one of (1) to (3), wherein said positive electrode active material layer includes a binder (b1),

said binder (b1) is an acrylic polymer including a monomer unit derived from (meth)acrylate, and

a content ratio of the monomer unit derived from (meth)acrylate in said acrylic polymer is 60 to 100 wt %.

(5) The all solid-state secondary battery as set forth in any one of (1) to (4), wherein said negative electrode active material layer includes binder (b2),

said binder (b2) is a diene polymer including a monomer unit derived from conjugated diene and monomer unit derived from aromatic vinyl,

a content ratio of said monomer unit derived from conjugated diene in said diene polymer is 30 to 70 wt %,

a content ratio of said monomer unit derived from said aromatic vinyl in said diene polymer is 30 to 70 wt %.

(6) A production method of the all solid-state secondary battery as set forth in any one of (1) to (5), wherein said production method comprises,

a step of forming a positive electrode active material layer by coating a slurry composition for positive electrode active material layer including a positive electrode active material, a solid electrolyte particle B and a binder (b1) to a current collector,

a step of forming a negative electrode active material layer by coating a slurry composition for the negative electrode active material layer including a negative electrode active material, a solid electrolyte particle B and a binder (b2) to a current collector,

a step of forming a solid electrolyte particle layer by coating a slurry composition for the solid electrolyte layer including a solid electrolyte particle A and a binder (a) to said positive electrode active material layer and/or said negative electrode active material layer,

a viscosity of said slurry composition for positive electrode active material layer or said slurry composition for the negative electrode active material layer is 3000 to 50000 mPa·s, and

a viscosity of said slurry composition for the solid electrolyte layer is 10 to 500 mPa·s.

### Effects of the Invention

According to the present invention, by using the solid electrolyte particle having particular particle diameter, the solid electrolyte layer can be made thin. Therefore, the all solid-state secondary battery having small internal resistance can be provided. Also, according to the present invention, by setting the viscosity of the slurry composition for positive electrode active material layer or the slurry composition for the negative electrode active material layer and the viscosity of the slurry composition for the solid electrolyte layer within a predetermined range, the slurry composition having good dispersibility and coating property can be obtained hence the solid electrolyte layer can be formed extremely thin. Thereby, the all solid-state secondary battery having small internal resistance can be provided. Also, by using these slurry compositions, the all solid-state secondary battery showing high ionic conductivity can be provided. Further, according to the present invention, the all solid-state secondary battery having superior productivity can be produced.

### MODES FOR CARRYING OUT THE INVENTION

### (The all Solid-State Secondary Battery)

The all solid-state secondary battery of the present invention comprises the positive electrode having the positive electrode active material layer, the negative electrode having the negative electrode active material layer, and the solid electrolyte layer between these positive and negative electrode active material layer. The positive electrode comprises the positive electrode active material layer on the current collector, and the negative electrode comprises the negative electrode active material layer on the current collector. Hereinafter, it will be explained in the order of (1) the solid electrolyte layer, (2) the positive electrode active material layer, (3) the negative electrode active material layer, and (4) the current collector.

### (1) The Solid Electrolyte Layer

The solid electrolyte layer is formed by coating the slurry composition for the solid electrolyte layer including the solid electrolyte particle A and preferably the binder (a) on to the positive electrode active material layer or the negative electrode active material layer which will be explained in below, and followed by drying. The slurry composition for the solid electrolyte layer is produced by kneading the solid electrolyte particle A, the binder (a), the organic solvent and other component added depending on the needs.

### (The Solid Electrolyte Particle A)

The average particle diameter (the number average particle diameter) of the solid electrolyte particle A is 1.5 μm or less, and preferably 0.3 to 1.3 μm. Also, the particle diameter of the 90% cumulative of the solid electrolyte particle A is 2.5 μm or less, and preferably 0.5 to 2.3 μm. When the average particle diameter and the particle diameter of the 90% cumulative of the solid electrolyte particle A are within said range, the slurry composition for the solid electrolyte layer having good dispersibility and the coating property can be obtained. If the average particle diameter of the solid electrolyte particle A becomes larger than 1.5 μm, the sedimentation speed of the solid electrolyte particle A in the slurry composition for the solid electrolyte layer is fast, thus it becomes difficult to form extremely thin even layer by the coating method or so. Also, when the 90% cumulative particle diameter of the solid electrolyte particle A becomes larger than 2.5 μm, the porosity in the solid electrolyte layer becomes high and the ionic conductivity decreases. When the particle diameter 90% cumulative or the average particle diameter of the solid electrolyte particle A is too small, the surface area of the particle increases and the organic solvent in said slurry composition becomes difficult to evaporate. Therefore, the drying time becomes longer, and the productivity of the battery declines.

The solid electrolyte particle A is not particularly limited as long as it has the conductivity of the lithium ion, however the crystalline inorganic lithium ion conductor or the amorphous inorganic lithium ion conductor are preferably included.

As the crystalline inorganic lithium ion conductor, Li₃N, LISICON(Li₁₄Zn(GeO₄)₄, perovskite type Li_{0.5}La_{0.5}TiO₃, LIPON(Li_{3+y}PO₄₋ₓNₓ), Thio-LISICON(Li_{3.25}Ge_{0.25}P_{0.75}S₄) or so may be mentioned.

As for the amorphous inorganic lithium ion conductor, it is not particularly limited as long as it includes S and comprises ion conductor. Here, when the all solid-state secondary battery of the present invention is the all solid-state lithium secondary battery, as for the used sulfide solid electrolyte material, those using the raw material comprising Li₂S and sulfide of the element of the group 13 to 15 may be mentioned. As for the method of the preparation of the sulfide solid electrolyte material using such raw material, for example the amorphous method may be mentioned. As for the amorphous method, for example, the mechanical milling method and the melt extraction method may be mentioned, and among these, the mechanical milling method is more preferable. According to the mechanical milling method, the process becomes possible under the normal temperature, and thus the production steps can be simplified.

As for above mentioned elements of the group 13 to 15, Al, Si, Ge, P, As, Sb or so may be mentioned. Also, as for the sulfide of the element of the group 13 to 15, specifically Al₂S₃, SiS₂, GeS₂, P₂S₃, P₂S₅, As₂S₃, Sb₂S₃ or so may be mentioned. Among these, in the present invention, the sulfides of the groups 14 or 15 are preferably used. Particularly, in the present invention, the sulfide solid electrolyte material using the source material comprising Li₂S and the sulfide of the element of group 13 to 15 is preferably Li₂S—P₂S₅ material, Li₂S—SiS₂ material, Li₂S—GeS₂ material, or Li₂S—Al₂S₃ material, and more preferably it is Li₂S—P₂S₅ material. This is because these have superior Li ion conductivity.

Also, the sulfide solid electrolyte material in the present invention preferably comprises the crosslinking sulfur. This is because, by comprising the crosslinking sulfur, the ionic conductivity increases. Further, in case the sulfide solid electrolyte material comprises the crosslinking sulfur, the reactivity with the positive electrode active material is high, and high resistance layer is easily formed, thus the effect of the present invention to suppress the generation of high resistance layer can be sufficiently exhibited. Note that, whether the sulfide solid electrolyte material “comprise the crosslinking sulfur”, for example, may be determined by examining the measurement result of Raman spectrum, the raw material ratio, and the measurement result of NMR or so.

The molar fraction of Li₂S in Li₂S—P₂S₅ material or Li₂S—Al₂S₃ is for example, preferably within the range 50 to 74%, and more preferably within the range of 60 to 74%. As long as it is within the range of the above mentioned range, the sulfide solid electrolyte material comprising crosslinking sulfur can be obtained further securely.

Also, the sulfide solid electrolyte material in the present invention may be sulfide glass, and also it may be a crystallized sulfide glass obtained by heat treating the sulfide glass thereof. The sulfide glass can be obtained for example by the above mentioned amorphous method. The crystallized sulfide glass can be obtained for example by heat treating the sulfide glass.

Particularly, in the present invention, the sulfide solid electrolyte material is preferably the crystallized sulfide glass expressed by Li₇P₃S₁₁. This is because it is particularly superior in the Li ion conductance. As for the method for preparing Li₇P₃S₁₁, it can be prepared for example by mixing Li₂S and P₂S₅ in the mol ratio of 70:30, then preparing the sulfide glass by forming into an amorphous using the ball mill, followed by heat treating the obtained sulfide glass at 150 to 360° C.

### (The Binder (a))

The binder (a) is for binding the solid electrolyte particles A against each other, and to form the solid electrolyte layer. As for the binder (a), for example, a polymer compound such as fluorine polymer, diene polymer, acrylic polymer, silicone polymer or so may be mentioned, and fluorine polymer, diene polymer and acrylic polymer are more preferable, further the acrylic polymer is further preferable since it allows to increase the withstand voltage and the energy density of the all solid-state secondary battery.

The acrylic polymer is a polymer including the monomer unit derived from (meth)acrylate, and specifically a homopolymer of (meth)acrylate, co-polymer of (meth)acrylate, and the copolymer between (meth)acrylate and other monomer copolymerizable with said (meth)acrylate may be mentioned.

As for (meth)acrylate, an alkyl ester acrylate such as methyl acrylate, ethyl acrylate, n-propyl acrylate, isopropyl acrylate, n-butyl acrylate, t-butyl acrylate, 2-ethylhexyl acrylate, benzyl acrylate or so; alcoxyalkyl ester acrylate such as 2-methoxyethyl acrylate, 2-ethoxyethyl acrylate or so; 2-(perfluoroalkyl)ethyl acrylate such as 2-(perfluorobutyl)ethyl acrylate, 2-(perfluoropentyl)ethyl acrylate or so; alkyl ester methacrylate such as methyl methacrylate, ethyl methacrylate, n-propyl methacrylate, isopropyl methacrylate, n-butyl methacrylate and t-butyl methacrylate, 2-ethylhexyl methacrylate, lauryl methacrylate, tridecyl methacrylate, stearyl methacrylate, benzyl methacrylate or so; 2-(perfluoroalkyl)ethyl methacrylate such as 2-(perfluorobutyl)ethyl methacrylate, 2-(perfluoropentyl)ethyl methacrylate or so; may be mentioned. Among these, alkyl ester acrylate such as methyl acrylate, ethyl acrylate, n-propyl acrylate, isopropyl acrylate, n-butyl acrylate, t-butyl acrylate, 2-ethylhexyl acrylate, benzyl acrylate or so; and alcoxyalkyl ester acrylate such as 2-methoxyethyl acrylate, 2-ethoxyethyl acrylate or so are preferable.

The content ratio of the monomer unit derived from (meth)acrylate in the acrylic polymer is usually 40 wt % or more and preferably 50 wt % or more, and more preferably 60 wt % or more. Note that, the upper limit of the content ratio of the monomer unit derived from (meth)acrylate in the acrylic polymer is usually 100 wt % or less, and preferably 95 wt % or less.

Also, as for the acrylic polymer, the copolymer of (meth)acrylate and the monomer copolymerizable with said (meth)acrylate is preferable. As for said copolymerizable monomer, unsaturated carboxylic acid such as acrylic acid, methacrylic acid, itaconic acid, fumaric acid or so; ester carboxylic acid having two or more of carbon-carbon double bond such as ethylene glycoldimethacrylate, diethylene glycoldimethacrylate, trimethylolpropanetriacrylate or so; styrene-based monomer such as styrene, chlorostyrene, vinyltoluene, t-butylstyrene, vinyl benzoate, vinyl methyl benzoate, vinyl naphthalene, chloromethylstyrene, hydroxymethylstyrene, α-methyl styrene, divinylbenzene or so; amide based monomer such as acrylic amide, methacrylic amide, N-methylolacrylicamide, acrylamide-2-methylpropane sulfate or so; α,β-unsaturated nitrile compound such as acrylonitrile, methacrylonitrile or so; olefins such as ethylene, propylene or so; diene based monomer such as butadiene, isoprene or so; halogen atom containing monomer such as vinyl chloride, vinylidene chloride or so; vinyl esters such as vinyl acetate, vinyl propionate, vinyl lactate, vinyl benzoate or so; vinyl ethers such as methylvinylether, ethylvinylether, butylvinylether or so; vinyl ketones such as methylvinylketone, ethylvinylketone, butylvinylketone, hexylvinylketone, isopropenylvinylketone or so; heterocyclic containing vinyl compounds such as N-vinylpyrrolidone, vinylpyridine, vinylimidazole or so may be mentioned. Among these, from the point of view of the solubility against the organic solvent, styrene-based monomer, amide based monomer, α,β-unsaturated nitrile compound are preferable. The content ratio of said copolymerizable monomer unit in the acrylic polymer is usually 60 wt % or less, preferably 55 wt % or less, more preferably 25 wt % or more and 45 wt % or less.

The production method of the acrylic polymer is not particularly limited, and any one of the solution polymerization method, the suspension polymerization method, the bulk polymerization method, the emulsion polymerization method or so may be used. As for the polymerization method, any one of the ion polymerization, the radical polymerization, the living radical polymerization or so may be used. As for the polymerization initiator used for the polymerization, the organic peroxides such as lauroyl peroxide, diisopropylperoxydicarbonate, di-2-ethylhexylperoxydicarbonate, t-butylperoxypivalate, 3,3,5-trimethylhexanoilperoxide or so; an azo compound such as α,α′-azobisisobutyronitrile or so; and ammonium persulfate, potassium persulfate or so may be mentioned.

The glass transition temperature (Tg) of the binder (a) is preferably −50 to 25° C., more preferably −45 to 15° C., particularly preferably −40 to 5° C. By having the Tg of the binder (a) within said range, the all solid-state secondary battery having superior strength and flexibility with high output characteristic can be obtained. Note that, the glass transition temperature of the binder (a) can be controlled by the combination of the various monomers.

The content of the binder (a) of the slurry composition for the solid electrolyte layer is preferably 0.1 to 10 parts by weight, more preferably 0.5 to 7 parts by weight and particularly preferably 0.5 to 5 parts by weight with respect to 100 parts by weight of solid electrolyte particle A. By having the content of the binder (a) within said range, the resistance of the solid electrolyte layer can be prevented from becoming large by interfering the lithium movement while maintaining the binding of the solid electrolyte particle A against each other.

### (The Organic Solvent)

As for the organic solvent, cycloaliphatic hydrocarbons such as cyclopentane, cyclohexane or so; and aromatic hydrocarbons such as toluene, xylene or so may be mentioned. These solvent can be used alone or by mixing two or more thereof and by suitably selecting from the point of view of drying speed and environmental point. Among these, in the present invention, from the point of the reactivity with the solid electrolyte particle A, the apolar solvent selected from the aromatic hydrocarbons is preferably used.

The content of the organic solvent of the slurry composition for the solid electrolyte layer is preferably 10 to 700 parts by weight, more preferably 30 to 500 parts by weight with respect to 100 parts by weight of the solid electrolyte particle A. By having the content of the organic solvent within said range, a good coating characteristics can be obtained while maintaining the dispersibility of the solid electrolyte particle A of the slurry composition for the solid electrolyte layer.

The slurry composition for the solid electrolyte layer may include, other than the above mentioned component, the component having the function as the dispersant, the leveling agent and the antifoaming agent as the other component added depending on the needs. These components are not particularly limited as long as it does not influence the battery reaction.

### (The Dispersant)

As for the dispersant, the anionic compound, the cationic compound, the non-ionic compound and the polymer may be mentioned as the examples. The dispersant is selected depending on the solid electrolyte particle used. The content of the dispersant in the slurry composition for the solid electrolyte layer is preferably within the range which does not influence the battery characteristics, and specifically it is 10 parts by weight or less with respect to 100 parts by weight of solid electrolyte particle.

### (The Leveling Agent)

As for the leveling agent, the surfactants such as the alkyl based surfactant, the silicone based surfactant, fluorine based surfactant, the metal based surfactant or so may be mentioned. By mixing the above mentioned surfactants, the repelling can be prevented which is generated when coating the slurry composition for the solid electrolyte layer which will be explained in the following to the surface of the positive electrode active material layer and the negative electrode active material layer, thereby the smoothness of the positive and the negative electrode can be improved. The content of the leveling agent of the slurry composition for the solid electrolyte layer is preferably within the range which does not influence the battery characteristic, and specifically it is 10 pats by weight or less with respect to 100 parts by weight of the solid electrolyte particle.

### (The Antifoaming Agent)

As for the antifoaming agent, a mineral oil antifoaming agent, a silicone antifoaming agent, a polymer antifoaming agent or so may be mentioned as examples. The antifoaming agent is selected in accordance with the solid electrolyte particle being used. The content of the antifoaming agent in the slurry composition for the solid electrolyte layer is preferably within the range which does not influence the battery characteristic, and specifically, it is 10 parts by weight or less with respect to 100 parts by weight of the solid electrolyte particle.

### (2) The Positive Electrode Active Material Layer

The positive electrode active material layer is formed by coating the slurry composition for the positive electrode active material layer including the positive electrode active material, the solid electrolyte particle B, and preferably the binder (b1) on to the current collector which will be explained in the following, then drying. The slurry composition for the positive electrode active material layer is produced by kneading the positive electrode active material, the solid electrolyte particle B, the binder (b1), the organic solvent and other component added depending on the needs.

### (The Positive Electrode Active Material)

The positive electrode active material is a compound capable to absorb and release the lithium ion. The positive electrode active material is separated by in large into those made from inorganic material and those made from organic material.

As for the positive electrode active material made from an inorganic material, a transition metal oxide, a composite oxide of lithium and the transition metal, and the transition metal sulfide or so may be mentioned. As for the above mentioned transition metal, Fe, Co, Ni, Mn or so may be used. As for the specific examples of the inorganic compounds used as the positive electrode active material, lithium containing composite metal oxide such as LiCoO₂, LiNiO₂, LiMnO₂, LiMn₂O₄, LiFePO₄, LiFeVO₄ or so; the transition metal sulfide such as TiS₂, TiS₃, amorphous MoS₂ or so; the transition metal oxide such as Cu₂V₂O₃, amorphous V₂O—P₂O₅, MoO₃, V₂O₅, V₆O₁₃ or so may be mentioned. These compounds may be partially substituted with other elements.

As for the positive electrode active material made from the organic material, for example, polyaniline, polypyrrole, polyacene, disulfide compound, polysulfide compound, N-fluoropyridinium salts or so may be mentioned. The positive electrode active material may be a mixture of above mentioned inorganic compound and the organic compound.

As for the average particle diameter of the positive electrode active material used in the present invention, it is usually 0.1 to 50 μm, and preferably 1 to 20 μm from the point of improving the battery characteristics such as the load characteristic, the cycle characteristic or so. When the average particle diameter is within the above mentioned range, the all solid-state secondary battery having large charge-discharge capacity can be obtained, and the handling of the slurry composition for the positive electrode active material layer and the handling during the production of the positive electrode is easy. The average particle diameter can be obtained by measuring the particle distribution using the laser diffraction.

### (The Solid Electrolyte Particle B)

The solid electrolyte particle B has the average particle diameter (the number average particle diameter) smaller than the average particle diameter of the above mentioned solid electrolyte particle A, and the difference therebetween is 0.3 μm or more, preferably 0.5 μm or more, further preferably 0.7 μm or more; and 2.0 μm or less, preferably 1.3 μm or less, further preferably 1.0 μm or less. When the difference of the average particle diameter of the solid electrolyte particle B and the average particle diameter of the solid electrolyte particle A is less than 0.3 μm or more than 2.0 μm, the adherence property between the solid electrolyte layer and the positive electrode active material layer declines, and the internal resistance in the electrode becomes large. Note that, as for the solid electrolyte particle B, those same as the above mentioned solid electrolyte particle A except for the particle diameter can be used, and those mentioned as the examples in the solid electrolyte particle A can be mentioned.

The weight ratio of positive electrode active material and the solid electrolyte particle B is positive electrode active material:solid electrolyte particle B=90:10 to 50:50, preferably 60:40 to 80:20. When the weight ratio of the positive electrode active material is smaller than the above mentioned range, the positive electrode active material amount in the battery decreases which leads to the decline of the capacity as the battery. Also, when the weight ratio of the solid electrolyte particle is smaller than the above mentioned range, a sufficient conductivity cannot be obtained, and the positive electrode active material cannot be effectively used thus it leads to the decline of the capacity as the battery.

(The Binder (b1))

The binder (b1) is for forming the positive electrode active material layer by binding the positive electrode active materials against each other, the solid electrolyte particles B against each other, and the positive electrode active material and the solid electrolyte particle B. As for the binder (b1), for example, a polymer such as fluorine polymer, diene polymer, acrylic polymer, silicone polymer or so may be mentioned, and the fluorine polymer, diene polymer, or acrylic polymer are preferable, and acrylic polymer is more preferable as it can increase the voltage resistance and the energy density of the all solid-state secondary battery.

The acrylic polymer is a polymer including the monomer unit derived from (meth)acrylate, and as for (meth)acrylate, those same as the binder (a) mentioned in the above described solid electrolyte layer can be mentioned. Also, the content ratio of the monomer unit derived from (meth)acrylate in the preferable acrylic polymer as the binder (b1) is preferably 60 to 100 wt %, and more preferably 65 to 90 wt %.

Also, as the acrylic polymer, the copolymer between (meth)acrylate and the monomer copolymerizable with said (meth)acrylate is preferable. The polymerization initiator used in the production method of said copolymerizable monomer and the acrylic polymer is same as those mentioned as the examples of the binder in the above mentioned solid electrolyte layer.

The glass transition temperature (Tg) of the binder (b1) is preferably −50 to 25° C., more preferably −45 to 15° C., and particularly preferably −40 to 5° C. By having Tg of the binder (b1) within the above mentioned range, the all solid-state secondary battery having superior strength and flexibility and high output characteristic can be obtained. Note that, the glass transition temperature of the binder (b1) can be controlled by combining various monomers.

The content of the binder (b1) in the slurry composition for the positive electrode active material layer is preferably 0.1 to 5 parts by weight, more preferably 0.2 to 4 parts by weight. By having the content of the binder (b1) within the above mentioned range, the positive electrode active material can be prevented from falling off the electrode without interrupting the battery reaction.

As for the organic solvent and other components added depending on the needs in the slurry composition for the positive electrode active material layer, those same as the above described solid electrolyte layer mentioned as examples can be used. The content of the organic solvent in the slurry composition for the positive electrode active material layer is preferably 20 to 80 parts by weight, more preferably 30 to 70 parts by weight with respect to 100 parts by weight of the positive electrode active material. By having the content of the organic solvent in the slurry composition for the positive electrode active material layer within the above mentioned range, a good coating characteristic can be obtained while maintaining the dispersibility of the solid electrolytes.

The slurry composition for the positive electrode active material layer may include, other than the above mentioned components, as other components depending on the needs, the additives exhibiting various functions such as conductor, reinforcing material or so. These are not particularly limited as long as it does not influence the battery reaction.

### (The Conducting Agent)

The conducting agent is not particularly limited as long as it can give conductivity, however usually the carbon powder such as acetylene black, carbon black, graphite or so, and fibers and foils of various metals may be mentioned.

### (The Reinforcing Material)

As for the reinforcing material, the filler having a spherical shape, a plate shape, a rod shape, or a fibrous shape of various organic and inorganic material can be used.

### (3) The Negative Electrode Active Material Layer

The negative electrode active material layer is formed by coating the slurry composition for the negative electrode active material layer including the negative electrode active material, the solid electrolyte particle B and preferably the binder (b2) to the current collector which will be described in below, and by drying. The slurry composition for the negative electrode active material layer is produced by kneading the negative electrode active material, the solid electrolyte particle B, the binder (b2), the organic solvent and other components added depending on the needs. Note that, as for the solid electrolyte particle B, the organic solvent, other components added depending on the needs in the slurry composition for the negative electrode active material layer, those as same as the positive electrode active material layer mentioned in the above as the examples may be used.

### (The Negative Electrode Active Material)

As for the negative electrode active material, the allotrope of carbon such as graphite or the cokes or so may be mentioned. The negative electrode active material made from the allotrope of said carbons may be used in the form of a coated body or the mixtures with such as metal, metal salts, and oxides or so. Also, as the negative electrode active material, the oxide salts or sulfide salts of silicon, tin, zinc, manganese, ferrous, nickel or so; lithium alloy such as lithium metal, Li—Al, Li—Bi—Cd, Li—Sn—Cd or so; lithium transition metal nitrides, silicon or so may be used. The average particle diameter of the negative electrode active material is usually 1 to 50 μm, and preferably 15 to 30 μm, from the point of improving the battery characteristics such as the initial efficiency, the load characteristics, and the cycle characteristics or so.

(The Binder (b2))

The binder (b2) is for forming the negative electrode active material layer by binding the negative electrodes active materials against each other, the solid electrolyte particle B against each other, and the negative electrode active material and the solid electrolyte particle B. As for the binder (b2), for example, the polymer such as fluorine polymer, diene polymer, acrylic polymer and silicone polymer or so may be mentioned. As for the binder (b2), the diene polymer including the monomer unit derived from the conjugated diene and the monomer unit derived from the aromatic vinyl is preferable.

In the diene polymer, the content ratio of the monomer unit derived from the conjugated diene is preferably 30 to 70 wt %, more preferably 35 to 65 wt %, and the content ratio of the monomer unit derived from the aromatic vinyl is preferably 30 to 70 wt %, more preferably 35 to 65 wt %. By having the content ratio of the monomer unit derived from the conjugated diene and the content ratio of the monomer unit derived from the aromatic vinyl within the above mentioned range, the negative electrode having high adherence property of the negative electrode active material against each other, the solid electrolyte particle B against each other, and between the particles of the negative electrode active material and the solid electrolyte particle B can be obtained.

As for the conjugated diene, butadiene, isoprene, 2-chloro-1,3-butadiene, chloroprene or so may be mentioned. Among these, butadiene is preferable.

As for the aromatic vinyl, styrene, chlorostyrene, vinyltoluene, t-butylstyrene, vinyl benzoate, vinyl methyl benzoate, vinyl naphthalene, chloromethylstyrene, hydroxymethylstyrene, α-methylstyrene, divinylbenzene or so may be mentioned. Among these, styrene, α-methylstyrene, divinylbenzene are preferable.

Also, the binder (b2) included in the negative electrode active material layer may be a copolymer of conjugated diene, aromatic vinyl and the monomer copolyrimerizable therewith. As for said copolymerizable monomer unit, α,β-unsaturated nitrile compounds such as acrylonitrile, methacrylonitrile or so; unsaturated carboxylic acid such as acrylic acid, methacrylic acid, itaconic acid, fumaric acid or so; olefins such as ethylene, propylene or so; halogen atom containing monomer such as vinyl chloride, vinylidene chloride or so; vinyl esters such as vinyl acetate, vinyl propionate, vinyl lactate, vinyl benzoate or so; vinyl ether such as methyl vinyl ether, ethyl vinyl ether, butyl vinyl ether or so; vinyl ketone such as methyl vinyl ketone, ethyl vinyl ketone, butyl vinyl ketone, hexyl vinyl ketone, isopropyl vinyl ketone or so; heterocyclic containing vinyl compound such as N-vinyl pyrrolidone, vinyl pyridine, vinyl imidazole or so may be mentioned. The content ratio of said copolymerizable monomer unit in diene type polymer is preferably 40 wt % or less, more preferably 20 wt % or more and 40 wt % or less.

The production method of the binder (b2) included in the negative electrode active material layer is not particularly limited, and any one of a solution polymerization method, a suspension polymerization method, a bulk polymerization method, an emulsify polymerization method or so may be used. As for the polymerization method, any one of an ion polymerization, a radical polymerization, a living radical polymerization or so may be used. As for the polymerization initiator used for the polymerization, for example, organic peroxides such as lauroyl peroxide, diisopropylperoxydicarbonate, di-2-ethylhexylperoxydicarbonate, t-butylperoxypivalate, 3,3,5-trimethylhexanoylperoxides or so; azo compounds such as α,α′-azobisisobutyronitrile or so; ammonium persulfate, potassium persulfate or so may be mentioned.

The glass transition temperature (Tg) of the binder (b2) is preferably −50 to 25° C., more preferably −45 to 15° C. and particularly preferably −40 to 5° C. By having the Tg of the binder (b2) within the above mentioned range, the all solid-sate secondary battery having good strength and flexibility, and high output characteristic can be obtained. Note that, the glass transition temperature of the binder (b2) can be controlled by combining various monomers.

The content of the binder (b2) in the slurry composition for the negative electrode active material layer is preferably 0.1 to 5 parts by weight, more preferably 0.2 to 4 parts by weight with respect to 100 parts by weight of the negative electrode active material. By having the content of the binder (b2) within the above mentioned range, the electrode active material can be prevented from falling off the electrodes without interrupting the battery reaction.

### (4) The Current Collector

The current collector is not particularly limited as long as it is a material comprising the electrical conductivity and the electrochemical resistance, however from the point of having the heat resistance, for example metal material such as ferrous, copper, aluminum, nickel, stainless steel, titanium tantalum, gold, platinum or so are preferable. Among these, aluminum is particularly preferable for the positive electrode and copper is particularly preferable for the negative electrode. The shape of the current collector is not particularly limited, however those having a sheet shape with the thickness of 0.001 to 0.5 mm or so is preferable. The current collector is preferably used by carrying out the roughening treatment in advance in order to enhance the adhesive strength between the positive/negative electrode active material layers. As for the roughening treatment method, a mechanical grinding method, an electrolytic grinding method, a chemical grinding method or so may be mentioned. As for the mechanical grinding method, a grinding cloth with the grinding particles, grind stone, emery wheel, a wire brush equipped with a steel wire or so may be used. Also, in order to enhance the adhesive strength or the conductivity between the current collector and the positive/negative electrode active material, an intermediate layer may be formed at the surface of the current collector.

### (The Production of the Slurry Composition for the Solid Electrolyte Layer)

The slurry composition for the slurry composition is obtained by mixing the above mentioned solid electrolyte particle A, a binder (a), an organic solvent and other components added depending on the needs.

### (The Production of the Slurry Composition for the Positive Electrode Active Material Layer)

The slurry composition for the positive electrode active material layer is obtained by mixing the above mentioned positive electrode active material, the solid electrolyte particle B, the binder (b1), the organic solvent and other components added depending on the needs.

### (The Production of the Slurry Composition for the Negative Electrode Active Material Layer)

The slurry composition for the negative electrode active material layer is obtained by mixing the above mentioned negative electrode active material, the solid electrolyte particle B, the binder (b2), the organic solvent and other components added depending on the needs.

The mixing method of the above mentioned slurry composition is not particularly limited, however for example the method using the mixing device of stirring method, a shaking method and a rotating method or so may be used. Also, the method using the disperse kneading machine such as a homogenizer, a ball mill, a beads mill, a planetary mixer, a sand mill, a roll mill, and a planetary kneader or so may be mentioned; from the point of view of suppressing the aggregation of the solid electrolyte particle, the planetary mixer, the ball mill or the beads mill are preferably used.

The viscosity of the slurry The slurry composition for the solid electrolyte layer produced as described in the above is 10 to 500 mPa·s, preferably 15 to 400 mPa·s, and more preferably 20 to 300 mPa·s. By having the viscosity of the slurry composition for the solid electrolyte layer within the above mentioned range, the dispersibility and the coating property of said slurry composition becomes good. If the viscosity of said slurry composition is less than 10 mPa·s, then the slurry composition for the solid electrolyte layer easily drips. Also, if the viscosity of said slurry composition is more than 500 mPa·s, then it becomes difficult to make the solid electrolyte layer thin.

The viscosity of the slurry composition for the positive electrode active material layer and the slurry composition for the negative electrode active material layer produced as described in above is 3000 to 50000 mPa·s, preferably 4000 to 30000 mPa·s, and more preferably 5000 to 10000 mPa·s. By having the viscosity of the slurry composition for the positive electrode active material layer and the slurry composition for the negative electrode active material layer within the above mentioned range, the dispersibility and the coating property of said slurry composition becomes good. If the viscosity of said slurry composition is less than 3000 mPa·s, then the active material and the solid electrolyte particle B in said slurry compositions easily precipitate. Also, if the viscosity of said slurry composition is more than 50000 mPa·s; the evenness of the coated film is decreased.

### (The all Solid-State Secondary Battery)

The all solid-state secondary battery of the present invention comprises a positive electrode having a positive electrode active material layer, a negative electrode having a negative electrode active material layer and a solid electrolyte layer placed between these positive/negative active material layers. The thickness of the solid electrolyte layer is 1 to 15 μm, preferably 2 to 13 μm, and more preferably 3 to 10 μm. By having the solid electrolyte layer within the above mentioned range, the internal resistance of the all solid-state secondary battery can be made small. If the thickness of the solid electrolyte layer is less than 1 μm, the all solid-state secondary battery will have short circuit. If the thickness of the solid electrolyte layer is larger than 15 μm, then the internal resistance of the battery becomes large.

The positive electrode of the all solid-state secondary battery of the present invention is produced by coating the above mentioned slurry composition for the positive electrode active material layer on the current collector and by forming the positive electrode active material layer by drying. Also, the negative electrode of the all solid-state secondary battery of the present invention is produced by coating the slurry composition for the negative electrode active material layer onto the current collector different from that of the positive electrode, then by forming the negative electrode active material layer by drying. Next, the slurry composition for the solid electrolyte layer is coated on the positive electrode active material layer or the negative electrode active material layer then the solid electrolyte layer is formed by drying. Then, the all solid-state secondary battery element is produced by pasting the electrode which did not form the solid electrolyte layer and the electrode which did form the above mentioned solid electrolyte layer against each other.

The coating method of the slurry composition for the positive electrode active material layer and the slurry composition for the negative electrode active material layer to the current collector is not particularly limited, and for example, it may be coated by a doctor blade method, a dip method, a reverse roll method, a direct roll method, a gravure method, a extrusion method or a brush method or so. The amount to be coated is also not particularly limited, and it is about the amount that the thickness of the active material layer formed after the organic solvent has been removed becomes usually 5 to 300 μm, preferably 10 to 250 μm or so. The drying method is also not particularly limited, and for example the drying by a warm air, a hot air, a low moisture air, the vacuum drying, a drying by an irradiation of (far) infrared ray or electron beam or so may be mentioned. The drying condition is controlled so that the organic solvent evaporates as fast as possible within the range so that the crack is not generated to the active material layer due to the focused stress or the active material layer is not released from the current collector. Further, the electrode may be stabilized by carrying out a press to the electrode which has been dried. As for the press method, a mold press or a calendar press or so may be mentioned; however it is not limited thereto.

The drying temperature is a temperature that the organic solvent sufficiently evaporates. Specifically, 50 to 250° C. is preferable, and 80 to 200° C. is further preferable. By setting within said range, the active material can be formed in good condition without having thermal decomposition of the binder. The drying time is not particularly limited, and usually it is 10 to 60 minutes.

The method for coating the solid electrolyte active material layer slurry composition to the positive electrode active material layer or the negative electrode active material layer is not particularly limited; and it is carried out as the same method as the coating method of the slurry composition for the positive electrode active material layer and the slurry composition for the negative electrode active material layer to the current collector; however the gravure method is preferable as it allows to form thin solid electrolyte layer. The amount to be coated is not particularly limited; and it is about the amount that the thickness of the solid electrolyte layer formed after the organic solvent has been removed becomes usually 1 to 15 μm, preferably 2 to 13 μm or so. The drying method, the drying condition, and the drying temperature are as same as that of the above mentioned slurry composition for the positive electrode active material layer and the slurry composition for the negative electrode active material layer.

Further, the pressure may be applied to the stacked body pasting the electrode formed with the above mentioned solid electrolyte layer and the electrode which did not form the solid electrolyte layer. The pressure applying method is not particularly limited; however for example a flat plate press, a roll press, a CIP (Cold Isostatic Press) or so may be mentioned. As for the pressure for pressure pressing, it is preferably 5 to 700 MPa, more preferably 7 to 500 MPa. By having the pressure of the pressure press within the above mentioned range, the resistance at each interface between the electrode and the solid electrolyte layer, and further the contact resistance between the particles in each layers becomes low, thereby good battery characteristic can be exhibited. Note that, the solid electrolyte layer and the active material layer are compressed due to the press, thus the thickness may be thinner than before the pressing. When carrying out the press, in regards with the thickness of the solid electrolyte layer and the active material layer according to the present invention, the thickness after the press may be within the above mentioned range.

The slurry composition for the solid electrolyte layer is not particularly limited whether to be coated to the positive electrode active material layer or the negative electrode active material layer, however the slurry composition for the solid electrolyte layer is preferably coated to the active layer having larger particle diameter of the used electrode active material. When the particle diameter of the electrode active material is large, the active material layer surface becomes rough, thus by coating the slurry composition, said roughness of the active material layer surface can be eased. Therefore, when pasting the electrode formed with the solid electrolyte layer and the electrode which is not formed with the solid electrolyte layer, the contact area between the solid electrolyte layer and the electrode becomes large thereby the interface resistance can be suppressed.

The all solid-state secondary battery can be obtained by placing the obtained all solid-state secondary battery element in its shape as it is or by rolling or bending depending on the shape of the battery and then by sealing. Also, if needed, an expand metal, an electrical fuse, an overcurrent prevention element such as a PTC element or so, and lead plate or so may be placed in the battery container thereby the pressure rising inside the battery and the excessive charge discharge can be prevented. The shape of the battery can be any one of a coin shape, a button shape, a sheet shape, a tubular shape, a square shape, a flat shape or so.

### EXAMPLES

Hereinafter, the present invention will be explained based on the examples; however the present invention is not to be limited thereto. Each characteristic are evaluated based on the following method. Note that. “parts” and “%” in the present examples are “parts by weight” and “wt %” respectively unless mentioned otherwise.

### <The Measurement of the Solid Electrolyte Layer Thickness>

According to JIS K5600-1-7:1999, using the scanning electron beam microscope (S-4700 made by Hitachi High-Tech Fielding Corporation) at 5000 magnification, the cross section of the all solid-state secondary battery solid electrolyte later after the pressing was observed and random ten points of electrolyte layer thickness were measured, thereby the solid electrolyte layer thickness was calculated from the average value thereof.

### <The Particle Diameter Measurement>

According to HS Z8825-1:2001, using the laser analysis device (Laser diffraction particle size analyzer SALD-3100 made by SHIMADZU Corporation), the particle diameter (the number average particle diameter) of 50% cumulative from the fine particle side of the cumulative particle size distribution and the particle diameter of 90% cumulative were measured.

### <The Viscosity Measurement>

According to JIS Z8803:1991, using the single rotating cylinder viscometer (RB80L made by TOKI SANGYO CO., LTD.) (25° C., rotating speed: 6 rpm, rotor shape: No. 1 (the viscosity 1000 mPa·s or less), No. 2 (the viscosity 1000 to 5000 mPa·s), No. 3 (the viscosity 5000 to 20000 mPa·s)), the viscosity at one minute after starting the measurement was measured and this was set as the slurry composition viscosity.

### <The Battery Characteristic: the Output Characteristic>

10 cells of the all solid-state secondary battery were charged up to 4.3V by the constant current method of 0.1 C, and then discharged to 3.0V at 0.1 C, thereby the discharge capacity (a) at 0.1 C was obtained. Next, it was charged to 4.3V at 0.1 C, and discharged to 3.0V at 10 C thereby the discharge capacity (b) at 10 C was obtained. The average value of 10 cells was set as the measured value, and the capacity holding rate expressed by the electrical capacity ratio (b/a (%)) between the discharge capacity (b) at 10 C and the discharge capacity (a) at 0.1 C was obtained, then this was set as the evaluation standard of the output characteristic to evaluate in the following standards. The higher this value is, the more superior the output characteristic is, that is it means that the internal resistance is small.

A: 70% or more
B: 60% or more and less than 70%
C: 40% or more and less than 60%
D: 20% or more and less than 40%
E: less than 20%

### <The Battery Characteristic: the Charge Discharge Cycle Characteristic>

By using the obtained all solid-state secondary battery, it was charged by constant current until 4.2V using the so called constant current constant voltage charge method at 0.5 C and 25° C. Then, the charge discharge cycle was carried out by charging by constant voltage and discharging to 3.0V at constant current of 0.5 C. The charge discharge cycles were carried out for 50 cycles, and the ratio of the discharge capacity at 50^{th} cycle with respect to the initial discharge capacity was set as the capacity holding rate and was evaluated according to the following standards. The larger this value is, the lesser the capacity decrease due to the repeating charge discharge cycle is, that is it means that the deterioration of the active material and the binder can be suppressed since the internal resistance is small, thus it indicates that the charge discharge cycle characteristic is good.

A: 60% or more
B: 55% or more and less than 60%
C: 50% or more and less than 55%
D: 45% or more and less than 50%
E: less than 45%

### Example 1

### <The Production of the Slurry Composition for the Positive Electrode Active Material Layer>

100 parts of lithium cobalate (the average particle diameter: 11.5 μm) as the positive electrode active material, 150 parts of sulfide glass comprising Li₂S and P₂S₅ (Li₂S/P₂S₅=70 mol %/30 mol %, the number average particle diameter: 0.4 μm) as the solid electrolyte particle B, 13 parts of acetylene black as the conducting agent, 3 parts of, in terms of solid portion, xylene solution of butyl acrylate-styrene copolymer (butyl acrylate/styrene copolymer ratio=70/30, Tg-2° C.) as the binder were added; and the solid portion concentration was controlled to 78% using xylene as the organic solvent, then mixed in the planetary mixer for 60 minutes. Further, after the solid portion concentration is controlled to 74% using xylene, it was mixed for 10 minutes thereby the slurry composition for the positive electrode active material layer was prepared. The viscosity of the slurry composition for the positive electrode active material layer was 6100 mPa·s.

### <The Production of the Slurry Composition for the Negative Electrode Active Material Layer>

100 parts of graphite (the average particle diameter: 20 μm) as the negative electrode active material, 50 parts of sulfide glass comprising Li₂S and P₂S₅ (Li₂S/P₂S₅=70 mol %/30 mol %, the number average particle diameter: 0.4 μm) as the solid electrolyte particle B, 3 parts, in terms of solid portion, of xylene solution of styrene-butadiene copolymer (styrene/butadiene copolymer ratio=50/50, Tg 20° C.) as the binder were mixed, and xylene as the organic solvent was further added to control the solid portion concentration to be 60% then the slurry composition for the negative electrode active material layer was prepared by mixing with the planetary mixer. The viscosity of the slurry composition for the negative electrode active material layer was 6100 mPa·s.

### <The Production of the Slurry Composition for the Solid Electrolyte Layer>

100 parts of sulfide glass comprising Li₂S and P₂S₅ (Li₂S/P₂S₅=70 mol %/30 mol %, the number average particle diameter: 1.2 μm, 90% cumulative particle diameter: 2.1 μm) as the solid electrolyte particle A, 3 parts of, in terms of solid portion, xylene solution of butyl acrylate-styrene copolymer (butyl acrylate/styrene copolymer ratio=70/30, Tg-2° C.) as the binder were mixed, and the solid portion concentration was controlled to 30% by adding xylene as the organic solvent and the slurry composition for the solid electrolyte layer was prepared by mixing with the planetary mixer. The viscosity of the slurry composition for the solid electrolyte layer was 52 mPa·s.

### <The Production of the all Solid-State Secondary Battery>

The above mentioned slurry composition for the positive electrode active material layer was coated to the current collector then dried (at 110° C. for 20 minutes) thereby the slurry composition for the positive electrode active material layer having 50 μm thickness was formed and the positive electrode was produced. Also, onto the surface of other current collector, the above mentioned slurry composition for the negative electrode active material layer was coated, then dried (at 110° C. for 20 minutes) thereby the negative electrode active material layer having 30 μm thickness was formed and the negative electrode was produced.

Next, onto the surface of the above mentioned positive electrode active material layer, the above mentioned slurry composition for the solid electrolyte layer was coated and dried (at 110° C. for 10 minutes) thereby the solid electrolyte layer having 11 μm thickness was formed.

The solid electrolyte layer stacked on the surface of the positive electrode active material layer and the negative electrode active material layer of the above mentioned negative electrode were pasted against each other and pressed; thereby the all solid-state secondary battery was obtained. The thickness of the solid electrolyte layer of the all solid-state secondary battery of after pressed was 9 μm. Also, the number average particle diameter of the solid electrolyte particle B was smaller than that of the solid electrolyte particle A, and the difference therebetween was 0.8 μm. The output characteristic and the charge discharge cycle characteristic were evaluated using this battery. The result is shown in Table 1.

### Example 2

The all solid-state secondary battery was produced and evaluated as same as the example 1 except for using the following slurry composition for the solid electrolyte layer. Note that, the thickness of solid electrolyte layer of the all solid-state secondary battery of after press was 7 μm. Also, the number average particle diameter of the solid electrolyte particle B was smaller than that of the solid electrolyte particle A, and the difference therebetween was 0.4 μm. The results are shown in Table 1.

100 parts of sulfide glass comprising Li₂S and P₂S₅ (Li₂S/P₂S₅=70 mol %/30 mol %, the number average particle diameter: 0.8 μm, 90% cumulative particle diameter: 1.8 μm) as the solid electrolyte particle A, 3 parts of in terms of solid portion, xylene solution of butyl acrylate-styrene copolymer (butyl acrylate/styrene copolymer ratio=70/30, Tg-2° C.) as the binder were mixed, and the solid portion concentration was controlled to 30% by adding xylene as the organic solvent and the slurry composition for the solid electrolyte layer was prepared by mixing with the planetary mixer. The viscosity of the slurry composition for the solid electrolyte layer was 130 mPa·s.

### Example 3

The all solid-state secondary battery was produced and evaluated as same as the example 1 except for controlling the solid portion concentration of the slurry composition for the solid electrolyte layer to 35% and coating to the above mentioned slurry composition for the solid electrolyte layer then drying (at 110° C. for 10 minutes) to form the solid electrolyte layer having the thickness of 17 μm, and thereby forming the solid electrolyte layer of the all solid-state secondary battery of after pressing having the thickness of 14 μm. Note that the viscosity of the slurry composition for the solid electrolyte layer was 130 mPa·s.

### Example 4

The all solid-state secondary battery was produced and evaluated as same as the example 1 except for controlling the solid portion concentration of the slurry composition for the positive electrode active material layer to 76% and controlling the viscosity of the slurry composition for the positive electrode active material layer to 9500 mPa·s.

### Example 5

The all solid-state secondary battery was produced and evaluated as same as the example 1 except for controlling the solid portion concentration of the slurry composition for the solid electrolyte layer to 37%, and coating the above mentioned slurry composition for the solid electrolyte layer, then drying (at 110° C. for 10 minutes) to form the solid electrolyte layer having the thickness of 19 μm, thereby forming the solid electrolyte layer of the all solid-state secondary battery of after pressing having the thickness of 15 μm. Note that, the viscosity of the slurry composition for the solid electrolyte layer was 280 mPa·s.

### Comparative Example 1

The all solid-state secondary battery was produced and evaluated as same as the example 1 except for controlling the solid portion concentration of the slurry composition for the solid electrolyte layer to 45%, and coating the above mentioned slurry composition for the solid electrolyte layer then drying (at 110° C. for 10 minutes) to form the solid electrolyte layer having the thickness of 30 μm, thereby forming the solid electrolyte layer of the all solid-state secondary battery of after pressing having 25 μm. Note that, the viscosity of the slurry composition for the solid electrolyte layer was 400 mPa·s.

### Comparative Example 2

The all solid-state secondary battery was produced and evaluated as same as the example 1 except for using the following slurry composition for the solid electrolyte layer. Note that, the thickness of the solid electrolyte layer of the all solid-state secondary battery of after pressing was 15 μm. Also, the number average particle diameter of the solid electrolyte particle B was smaller than that of the solid electrolyte particle A, and the difference therebetween was 1.4 μm. The results are shown in Table 1.

100 parts of sulfide glass consisting of Li₂S and P₂S₅ (Li₂S/P₂S₅=70 mol %/30 mol %, the number average particle diameter: 1.8 μm, 90% cumulative particle diameter: 2.5 μm) as the solid electrolyte particle A, 3 parts of, in terms of solid portion, xylene solution of butyl acrylate-styrene copolymer (butyl acrylate/styrene copolymer ratio=70/30, Tg-2° C.) as the binder were mixed, and the solid portion concentration was controlled to 33% by adding xylene as the organic solvent and the slurry composition for the solid electrolyte layer was prepared by mixing with the planetary mixer. The viscosity of the slurry composition for the solid electrolyte layer was 47 mPa·s.

### Comparative Example 3

The all solid-state secondary battery was produced and evaluated as same as the example 1 except for using the following slurry composition for the solid electrolyte layer. Note that, the thickness of the solid electrolyte layer of the all solid-state secondary battery of after pressing was 15 μm. Also, the number average particle diameter of the solid electrolyte particle B was smaller than that of the solid electrolyte particle A, and the difference therebetween was 0.9 μm. The results are shown in Table 1.

100 parts of sulfide glass comprising Li₂S and P₂S₅ (Li₂S/P₂S₅=70 mol %/30 mol %, the number average particle diameter: 1.3 μm, 90% cumulative particle diameter: 3.0 μm) as the solid electrolyte particle A, 3 parts of, in terms of solid portion, xylene solution of butyl acrylate-styrene copolymer (butyl acrylate/styrene copolymer ratio=70/30, Tg-2° C.) as the binder were mixed, and the solid portion concentration was controlled to 32% by adding xylene as the organic solvent and the slurry composition for the solid electrolyte layer was prepared by mixing with the planetary mixer. The viscosity of the slurry composition for the solid electrolyte layer was 44 mPa·s.

### Comparative Example 4

The all solid-state secondary battery was produced and evaluated as same as the example 1 except for using the following slurry composition for the solid electrolyte layer. Note that, the viscosity of the slurry composition for the solid electrolyte layer was 52 mPa·s. Also, the thickness of the solid electrolyte layer of the all solid-state secondary battery of after pressing was 9 μm. Further, the number average particle diameter of the solid electrolyte particle B was larger than that of the solid electrolyte particle A, and the difference therebetween was −0.8 μm. The results are shown in Table 1.

100 parts of lithium cobalate (the average particle diameter: 11.5 μm) as the positive electrode active material, 150 parts of sulfide glass comprising Li₂S and P₂S₅ (Li₂S/P₂S₅=70 mol %/30 mol %, the number average particle diameter: 2.0 μm) as the solid electrolyte particle B, 13 parts of acetylene black as the conducting agent, 3 parts of in terms of solid portion, xylene solution of butyl acrylate-styrene copolymer (butyl acrylate/styrene copolymer ratio=70/30, Tg-2° C.) as the binder were added; and the solid portion concentration was controlled to 80% using xylene as the organic solvent, then mixed in the planetary mixer for 60 minutes. Further, after the solid portion concentration is controlled to 77% using xylene, it was mixed for 10 minutes thereby the slurry composition for the positive electrode active material layer was prepared. The viscosity of the slurry composition for the positive electrode active material layer was 4800 mPa·s.

100 parts of graphite (the average particle diameter: 24 μm) as the negative electrode active material, 50 parts of sulfide glass comprising Li i₂S and P₂S₅ (Li₂S/P₂S₅=70 mol %/30 mol %, the number average particle diameter: 2.0 μm) as the solid electrolyte particle B, 3 parts, in terms of solid portion, of xylene solution of styrene-butadiene copolymer (styrene I butadiene copolymer ratio=50/50, Tg 20° C.) as the binder were mixed, and xylene as the organic solvent was further added to control the solid portion concentration to be 65% then the slurry composition for the negative electrode active material layer was prepared by mixing with the planetary mixer. The viscosity of the slurry composition for the negative electrode active material layer was 4800 mPa·s.

### Comparative Example 5

The all solid-state secondary battery was produced and evaluated as same as the example 1 except for using the following slurry composition for the solid electrolyte layer. Note that, the viscosity of the slurry composition for the solid electrolyte layer was 52 mPa·s. Also, the thickness of the solid electrolyte layer of the all solid-state secondary battery of after pressing was 9 μm. Further, the number average particle diameter of the solid electrolyte particle B was same as that of the solid electrolyte particle A. The results are shown in Table 1.

100 parts of lithium cobalate (the average particle diameter: 11.5 μm) as the positive electrode active material, 150 parts of sulfide glass comprising Li₂S and P₂S₅ (Li₂S/P₂S₅=70 mol %/30 mol %, the number average particle diameter: 1.2 μm) as the solid electrolyte particle B, 13 parts of acetylene black as the conducting agent, 3 parts of, in terms of solid portion, xylene solution of butyl acrylate-styrene copolymer (butyl acrylate/styrene copolymer ratio=70/30, Tg-2° C.) as the binder were added; and the solid portion concentration was controlled to 80% using xylene as the organic solvent, then mixed in the planetary mixer for 60 minutes. Further, after the solid portion concentration is controlled to 76% using xylene, it was mixed for 10 minutes thereby the slurry composition for the positive electrode active material layer was prepared. The viscosity of the slurry composition for the positive electrode active material layer was 5300 mPa·s.

100 parts of graphite (the average particle diameter: 20 μm) as the negative electrode active material, 50 parts of sulfide glass comprising Li i₂S and P₂S₅ (Li₂S/P₂S₅=70 mol %/30 mol %, the number average particle diameter: 1.2 μm) as the solid electrolyte particle B, 3 parts, in terms of solid portion, of xylene solution of styrene-butadiene copolymer (styrene/butadiene copolymer ratio=50/50, Tg 20° C.) as the binder were mixed, and xylene as the organic solvent was further added to control the solid portion concentration to be 65% then the slurry composition for the negative electrode active material layer was prepared by mixing with the planetary mixer. The viscosity of the slurry composition for the negative electrode active material layer was 5300 mPa·s.

TABLE 1

| | | | The 90% cumurative | | |
|---|---|---|---|---|---|
| | Thickness of | The average particle | particle diameter of | The average particle | The difference between the |
| | the solid | diameter of the solid | the solid electrolyte | diameter of the solid | average particle diameter |
| | electrolyte layer | electrolyte particle A | particle A | electrolyte particle B | (particle A − particle B) |
| | (μm) | (μm) | (μm) | (μm) | (μm) |
| Example 1 | 9 | 1.2 | 2.1 | 0.4 | 0.8 |
| Example 2 | 7 | 0.8 | 1.8 | 0.4 | 0.4 |
| Example 3 | 14 | 1.2 | 2.1 | 0.4 | 0.8 |
| Example 4 | 9 | 1.2 | 2.1 | 0.4 | 0.8 |
| Example 5 | 15 | 1.2 | 2.1 | 0.4 | 0.8 |
| Comparative | 25 | 1.2 | 2.1 | 0.4 | 0.8 |
| Example 1 | | | | | |
| Comparative | 15 | 1.8 | 2.5 | 0.4 | 1.4 |
| Example 2 | | | | | |
| Comparative | 15 | 1.3 | 3.0 | 0.4 | 0.9 |
| Example 3 | | | | | |
| Comparative | 9 | 1.2 | 2.1 | 2.0 | −0.8 |
| Example 4 | | | | | |
| Comparative | 9 | 1.2 | 2.1 | 1.2 | 0 |
| Example 5 | | | | | |

| | The viscosity of the slurry | The viscosity of the | The output | | The charge discharge | |
|---|---|---|---|---|---|---|
| | compositions of the | slurry composition | characteristic | | cycle characteristic | |
| | positive/negative electrode | of the solid | The capacity | | The capacity | |
| | active material layer | electrolyte layer | holding rate | | holding rate | |
| | (mPa · s) | (mPa · s) | (%) | Evaluation | (%) | Evaluation |
| Example 1 | 6100 | 52 | 81 | A | 62 | A |
| Example 2 | 6100 | 130 | 78 | B | 59 | B |
| Example 3 | 6100 | 130 | 72 | B | 58 | B |
| Example 4 | positive electrode (9500): | 52 | 80 | A | 60 | A |
| | negative electrode (6100) | | | | | |
| Example 5 | 6100 | 280 | 70 | B | 59 | B |
| Comparative | 6100 | 400 | 29 | E | 49 | D |
| Example 1 | | | | | | |
| Comparative | 6100 | 47 | 33 | D | 47 | D |
| Example 2 | | | | | | |
| Comparative | 6100 | 44 | 30 | D | 48 | D |
| Example 3 | | | | | | |
| Comparative | 4800 | 52 | 27 | D | 39 | E |
| Example 4 | | | | | | |
| Comparative | 5300 | 52 | 43 | D | 46 | D |
| Example 5 | | | | | | |

According to the results of Table 1, it is clear that the solid electrolyte layer can be made thin by using the all solid-state secondary battery wherein the solid electrolyte layer has a thickness of 1 to 15 μm, the solid electrolyte layer comprising the solid electrolyte particle A having the average particle diameter of 1.5 μm or less, the 90% cumulative particle diameter of the solid electrolyte particle A is 2.5 μm or less, the positive electrode active material layer and the negative electrode active material layer includes the solid electrolyte particle B, the average particle diameter of the solid electrolyte particle B is smaller than that of the solid electrolyte particle A and the difference therebetween is 0.3 μm or more. Thereby, the internal resistance of the all solid-state secondary battery can be made small.

Also, according to the production method of the all solid-state secondary battery comprising; the step of forming the positive electrode active material layer by coating the slurry composition for the positive electrode active material layer comprising the binder and the positive electrode active material to the current collector, the step of forming the negative electrode active material layer by coating the slurry composition for the negative electrode active material layer comprising the binder and the negative electrode active material to the current collector, and the step of forming the solid electrolyte layer by coating the slurry composition for the solid electrolyte layer comprising the solid electrolyte particle A and binder to the positive electrode active material layer and/or the negative electrode active material layer; and the viscosity of the slurry composition for the positive electrode active material layer or the slurry composition for the negative electrode active material layer is 3000 to 20000 mPa·s, the viscosity of the slurry composition for the solid electrolyte layer is 10 to 500 mPa·s; the slurry composition having good dispersibility and coating property can be obtained thus solid electrolyte layer can be made extremely thin. Thereby the internal resistance of the all solid-state secondary battery can be made small. Also by using these slurry compositions, the ionic conductivity of the all solid-state secondary battery can be enhanced. Furthermore, the all solid-state secondary battery of the present invention has good productivity.

1. An all solid-state secondary battery comprising a positive electrode having positive electrode active material layer, a negative electrode having negative electrode active material layer and a solid electrolyte layer between these positive and negative electrodes; wherein
a thickness of said solid electrolyte layer is 1 to 15 μm,
said solid electrolyte layer includes a solid electrolyte particle A having an average particle diameter of 1.5 μm or less,
a 90% cumulative particle diameter of said solid electrolyte particle A is 2.5 μm or less,
said positive electrode active material layer and said negative electrode active material layer includes a solid electrolyte particle B,
an average particle diameter of said solid electrolyte particle B is smaller than the average particle diameter of said solid electrolyte particle A, and a difference therebetween is 0.3 μm or more and 2.0 μm or less.

2. The all solid-state secondary battery as set forth in claim 1 wherein said solid electrolyte particle A and/or said solid electrolyte particle B are sulfide glass comprising Li₂S and P₂S₅.

3. The all solid-state secondary battery as set forth in claim 1, wherein said solid electrolyte layer includes a binder (a),
said binder (a) is an acrylic polymer including a monomer unit derived from (meth)acrylate.

4. The all solid-state secondary battery as set forth in claim 1, wherein said positive electrode active material layer includes a binder (b1),
said binder (b1) is an acrylic polymer including a monomer unit derived from (meth)acrylate, and
a content ratio of the monomer unit derived from (meth)acrylate in said acrylic polymer is 60 to 100 wt %.

5. The all solid-state secondary battery as set forth in claim 1, wherein said negative electrode active material layer includes binder (b2),
said binder (b2) is a diene polymer including a monomer unit derived from conjugated diene and monomer unit derived from aromatic vinyl,
a content ratio of said monomer unit derived from conjugated diene in said diene polymer is 30 to 70 wt %,
a content ratio of said monomer unit derived from said aromatic vinyl in said diene polymer is 30 to 70 wt %.

6. A production method of the all solid-state secondary battery as set forth in claim 1, wherein said production method comprises,
a step of forming a positive electrode active material layer by coating a slurry composition for a positive electrode active material layer including a positive electrode active material, a solid electrolyte particle B and a binder (b1) to a current collector,
a step of forming a negative electrode active material layer by coating a slurry composition for negative electrode active material layer including a negative electrode active material, a solid electrolyte particle B and a binder (b2) to a current collector,
a step of forming a solid electrolyte particle layer by coating a slurry composition for solid electrolyte layer including a solid electrolyte particle A and a binder (a) to said positive electrode active material layer and/or said negative electrode active material layer,
a viscosity of said slurry composition for positive electrode active material layer or said slurry composition for negative electrode active material layer is 3000 to 50000 mPa·s, and
a viscosity of said slurry composition solid electrolyte layer is 10 to 500 mPa·s.

7. The all solid-state secondary battery as set forth in claim 2, wherein said solid electrolyte layer includes a binder (a),
said binder (a) is an acrylic polymer including a monomer unit derived from (meth)acrylate.

8. The all solid-state secondary battery as set forth in claim 2, wherein said positive electrode active material layer includes a binder (b1),
said binder (b1) is an acrylic polymer including a monomer unit derived from (meth)acrylate, and
a content ratio of the monomer unit derived from (meth)acrylate in said acrylic polymer is 60 to 100 wt %.

9. The all solid-state secondary battery as set forth in claim 3, wherein said positive electrode active material layer includes a binder (b1),
said binder (b1) is an acrylic polymer including a monomer unit derived from (meth)acrylate, and
a content ratio of the monomer unit derived from (meth)acrylate in said acrylic polymer is 60 to 100 wt %.

10. The all solid-state secondary battery as set forth in claim 2, wherein said negative electrode active material layer includes binder (b2),
said binder (b2) is a diene polymer including a monomer unit derived from conjugated diene and monomer unit derived from aromatic vinyl,
a content ratio of said monomer unit derived from conjugated diene in said diene polymer is 30 to 70 wt %,
a content ratio of said monomer unit derived from said aromatic vinyl in said diene polymer is 30 to 70 wt %.

11. The all solid-state secondary battery as set forth in claim 3, wherein said negative electrode active material layer includes binder (b2),
said binder (b2) is a diene polymer including a monomer unit derived from conjugated diene and monomer unit derived from aromatic vinyl,
a content ratio of said monomer unit derived from conjugated diene in said diene polymer is 30 to 70 wt %,
a content ratio of said monomer unit derived from said aromatic vinyl in said diene polymer is 30 to 70 wt %.

12. The all solid-state secondary battery as set forth in claim 4, wherein said negative electrode active material layer includes binder (b2),
said binder (b2) is a diene polymer including a monomer unit derived from conjugated diene and monomer unit derived from aromatic vinyl,
a content ratio of said monomer unit derived from conjugated diene in said diene polymer is 30 to 70 wt %,
a content ratio of said monomer unit derived from said aromatic vinyl in said diene polymer is 30 to 70 wt %.

13. A production method of the all solid-state secondary battery as set forth in claim 2, wherein said production method comprises,
a step of forming a positive electrode active material layer by coating a slurry composition for a positive electrode active material layer including a positive electrode active material, a solid electrolyte particle B and a binder (b1) to a current collector,
a step of forming a negative electrode active material layer by coating a slurry composition for negative electrode active material layer including a negative electrode active material, a solid electrolyte particle B and a binder (b2) to a current collector,
a step of forming a solid electrolyte particle layer by coating a slurry composition for solid electrolyte layer including a solid electrolyte particle A and a binder (a) to said positive electrode active material layer and/or said negative electrode active material layer,
a viscosity of said slurry composition for positive electrode active material layer or said slurry composition for negative electrode active material layer is 3000 to 50000 mPa·s, and
a viscosity of said slurry composition solid electrolyte layer is 10 to 500 mPa·s.

14. A production method of the all solid-state secondary battery as set forth in claim 3, wherein said production method comprises,
a step of forming a positive electrode active material layer by coating a slurry composition for a positive electrode active material layer including a positive electrode active material, a solid electrolyte particle B and a binder (b1) to a current collector,
a step of forming a negative electrode active material layer by coating a slurry composition for negative electrode active material layer including a negative electrode active material, a solid electrolyte particle B and a binder (b2) to a current collector,
a step of forming a solid electrolyte particle layer by coating a slurry composition for solid electrolyte layer including a solid electrolyte particle A and a binder (a) to said positive electrode active material layer and/or said negative electrode active material layer,
a viscosity of said slurry composition for positive electrode active material layer or said slurry composition for negative electrode active material layer is 3000 to 50000 mPa·s, and
a viscosity of said slurry composition solid electrolyte layer is 10 to 500 mPa·s.

15. A production method of the all solid-state secondary battery as set forth in claim 4, wherein said production method comprises,
a step of forming a positive electrode active material layer by coating a slurry composition for a positive electrode active material layer including a positive electrode active material, a solid electrolyte particle B and a binder (b1) to a current collector,
a step of forming a negative electrode active material layer by coating a slurry composition for negative electrode active material layer including a negative electrode active material, a solid electrolyte particle B and a binder (b2) to a current collector,
a step of forming a solid electrolyte particle layer by coating a slurry composition for solid electrolyte layer including a solid electrolyte particle A and a binder (a) to said positive electrode active material layer and/or said negative electrode active material layer,
a viscosity of said slurry composition for positive electrode active material layer or said slurry composition for negative electrode active material layer is 3000 to 50000 mPa·s, and
a viscosity of said slurry composition solid electrolyte layer is 10 to 500 mPa·s.

16. A production method of the all solid-state secondary battery as set forth in claim 5, wherein said production method comprises,
a step of forming a positive electrode active material layer by coating a slurry composition for a positive electrode active material layer including a positive electrode active material, a solid electrolyte particle B and a binder (b1) to a current collector,
a step of forming a negative electrode active material layer by coating a slurry composition for negative electrode active material layer including a negative electrode active material, a solid electrolyte particle B and a binder (b2) to a current collector,
a step of forming a solid electrolyte particle layer by coating a slurry composition for solid electrolyte layer including a solid electrolyte particle A and a binder (a) to said positive electrode active material layer and/or said negative electrode active material layer,
a viscosity of said slurry composition for positive electrode active material layer or said slurry composition for negative electrode active material layer is 3000 to 50000 mPa·s, and
a viscosity of said slurry composition solid electrolyte layer is 10 to 500 mPa·s.
